(19) United States
(12) Patent Application Publication
(10) Pub. No.: US 2015/0321653 A1
(43) Pub. Date: Nov. 12, 2015

(54) SWITCHOVER METHOD FOR A SOLENOID VALVE OPERATED IN ANALOGIZED FORM, ELECTROHYDRAULIC BRAKE SYSTEM, AND USE OF THE ELECTROHYDRAULIC BRAKE SYSTEM

(71) Applicant: Continental Teves AG & Co. oHG, Frankfurt (DE)

(72) Inventors: Andreas Neu, Kuhardt (DE); Ralph Gronau, Wetter (DE); Holger Kollmann, Rodgau (DE); Jörg Berntheusel, Neu Anspach (DE); Tobias Franke, Hofheim (DE)

(21) Appl. No.: 14/424,253

(22) PCT Filed: Aug. 27, 2013
(86) PCT No.: PCT/EP2013/067715

§ 371 Date: Feb. 26, 2015

(30) Foreign Application Priority Data
Aug. 29, 2012 (DE) 10 2012 215 353.5

(51) Int. Cl. B60T 13/68; B60T 13/14; F16K 31/06

(52) U.S. Cl. CPC B60T 13/686; F16K 31/0675; B60T 13/142

(57) ABSTRACT

A switchover method for a solenoid valve, operated in analogized form, in an electrohydraulic brake system, in which method the solenoid valve can assume a closed position, an open position and a multiplicity of intermediate positions in accordance with electrical actuation or regulation, and wherein the actuation or regulation is performed as a function of a known current-pressure characteristic curve of the solenoid valve. Upon a switchover of the solenoid valve, a pressure-dependent and/or current-dependent magnetic hysteresis characteristic of the solenoid valve is compensated directly without prior modification of the present hysteresis characteristic. An electrohydraulic brake system and the use of the brake system is also disclosed.

### CROSS REFERENCE TO RELATED APPLICATIONS

This application is the U.S. National Phase of PCT International Application No. PCT/EP2013/067715, filed Aug. 27, 2013, which claims priority to German Patent Application No. 10 2012 215 353.5, filed Aug. 29, 2012, the contents of such applications being incorporated by reference herein.

### FIELD OF THE INVENTION

The invention relates to a switchover method for a solenoid valve operated in analogized form, an electrohydraulic brake system, and the use thereof.

### BACKGROUND OF THE INVENTION

The most precise possible control of analogized digital valves in motor vehicle brake systems with electrohydraulic pressure regulation is an increasingly important precondition for a multiplicity of different comfort functions such as, in particular, adaptive cruise control systems and cruise control systems which are becoming ever more popular. Although the known use of pressure sensors in each individual wheel brake cylinder permits precise pressure measurement at all times and along with this precise adjustment of the necessary brake pressure, this gives rise to high costs for the additional pressure sensors, and entails relatively high overall costs of the brake system, which in turn has an unfavorable effect on the commercial competiveness of such systems.

A possible way known from the prior art for avoiding additional pressure sensors and the associated additional manufacturing costs is to measure the opening current or closing current in the form of a characteristic curve which correlates a pressure difference present at the valve with an exciter current. This permits, even without additional pressure sensors, essentially precise pressure regulation by means of an analogized hydraulic valve. Such a method is disclosed, for example, in DE 102 24 059 A1, which is incorporated by reference. The characteristic curve is stored here electronically in the regulating system and a pressure difference can subsequently be set in a selective fashion by means of the exciter current, without having to have a recourse to additionally measured pressure data.

DE 10 2005 051 436 A1, which is incorporated by reference, also proposes a method for regulating pressure in a hydraulic brake system without using additional pressure sensors. In this context, the analogized hydraulic valves are calibrated by means of the ABS wheel rotational speed sensors which are present in the vehicle and which determine a reduction in the rotational speed and therefore a braking effect as a function of the exciter current. This method permits valve calibration directly in the vehicle itself without using additional measuring sensors. The actuation characteristic curve which is determined in such a way is stored electronically and used for pressure regulation.

DE 10 2008 006 653 A1, which is incorporated by reference, discloses a method for conditioning a regulating valve. In this context, an anti-hysteresis pulse is briefly applied to at least one electrically actuated solenoid valve in an electrohydraulic pressure regulating assembly which is operated during pressure regulation with a specific working current in accordance with a relationship or characteristic diagram stored in the pressure regulating assembly, during the setting of a current far below or far above the working current. In particular, the anti-hysteresis pulse occurs before each build-up of pressure or each reduction in pressure and is dimensioned to be so short that the brake pressure is influenced as little as possible.

A disadvantage of the methods known from the prior art for sensorless pressure regulation in a vehicle brake system is, however, that these analogized solenoid valves which are customarily used by means of occurring hysteresis effects of the ferromagnetic valve yoke are inevitably inaccurate. However, if this unfavorable influence of the hysteresis effects according to the prior art is avoided by means of anti-hysteresis pulses, the sudden change in current which is associated with the anti-hysteresis pulses often brings about an undesired reaction of the vehicle brake system, which can be perceived by the driver, in the form of noise or changes in braking force.

### SUMMARY OF THE INVENTION

An aspect of the present invention is a method which very largely avoids the unfavorable influence of the hysteresis effect when there is a switchover of analogized solenoid valves, and at the same time does not adversely affect the comfort as a result of noise or changes in braking force which can be perceived by the driver.

According to the inventive switchover method for a solenoid valve operated in an analogized form in an electrohydraulic brake system, a closed position, an open position and a multiplicity of intermediate positions can be assumed by the solenoid valve in accordance with electrical actuation or regulation, wherein the actuation or regulation is in turn performed in accordance with a known current-pressure characteristic curve of the solenoid valve. The inventive switchover method is distinguished by the fact that when there is a switchover of the solenoid valve a pressure-dependent and/or current-dependent magnetic hysteresis characteristic of the solenoid valve is compensated directly without a preceding change in the present hysteresis characteristic. This results in the advantage that when there is a switchover, that is to say a change in direction of the movement of the valve tappet, a currently present hysteresis characteristic of the valve yoke is allowed for, and the compensation thereof brings about an essentially immediate reaction by the solenoid valve. This in turn permits immediate and selective influencing of the pressure within the brake system, and therefore effective and rapid setting of a desired target pressure.

The hysteresis effect occurs usually in hysteresis characteristics which are of differing magnitudes and which are dependent on the geometry of the solenoid valve, in particular on the geometry of the magnetizable valve yoke or of a valve component of the solenoid valve which corresponds to the valve yoke, insofar as said solenoid valve differs from a customary valve design. Furthermore, the hysteresis characteristic is determined by the material of the solenoid valve, in particular by the material of the valve yoke, and the electric current which was last present at the solenoid valve or the pressure which was last present at the solenoid valve.

In this context it is according to the invention irrelevant whether the switchover is performed from an actually reached end position, that is to say the closed position or the open position, or is performed only from an intermediate position. All that is significant is that a change takes place in the direction of movement of the valve tappet which was last implemented, even if the solenoid valve or the valve tappet stayed in the meantime for a certain period of time in a particular position before a movement occurred in the opposing direction of the direction of movement last implemented.

There is preferably provision that the switchover is performed from a valve-opening movement to a valve-closing movement. This means therefore that the change in direction of the movement of the valve tappet is performed from a valve-opening movement to a valve-closing movement. Such a switchover is typically performed at the changeover from a pressure reduction process to a pressure build-up process in the brake system. Since a sufficiently large magnetic force therefore has to be generated quickly particularly in the case of a switchover from a valve-opening movement to a valve-closing movement counter to a pressure acting on the valve in the opening direction, the method according to the invention exhibits particular advantages here since the hysteresis characteristic which is present in this case and which also makes the valve-closing movement difficult is compensated from the outset.

Furthermore, it is preferred that the magnetic hysteresis characteristic is compensated by means of a current offset which is added to the current-pressure characteristic curve. The current-pressure characteristic curve indicates here a current which, depending on whether it is a solenoid valve which is open in the currentless state or closed in the currentless state, brings about opening, closing or holding of a current valve position or tappet position, depending on the pressure acting on the solenoid valve. A valve characteristic which is already known is therefore used to compensate the pressure-dependent and current-dependent magnetic hysteresis characteristic, on the basis of said valve characteristic, by means of the current offset.

In particular it is preferred that the current offset is determined as a function of the setpoint pressure and/or setpoint current present at the solenoid valve directly before the switchover is performed. This provides the advantage that the current offset is adapted in as far as possible an optimum way to the actual hysteresis characteristic, since said hysteresis characteristic is determined decisively by the setpoint current and setpoint pressure. Depending on the direction of the switchover (from a valve-opening movement to a valve-closing movement, or vice versa), the sign of the current offset should also be considered since it can also be negative.

It is quite particularly preferred that a value of the current offset is read out from a current-dependent and/or pressure-dependent hysteresis characteristic diagram or a current-dependent and/or pressure-dependent hysteresis characteristic curve. There is therefore no need for continuous re-calculation of the value of the current offset, but instead the latter can easily be read out from a current-dependent and/or pressure-dependent hysteresis characteristic diagram or a current-dependent and/or pressure-dependent hysteresis characteristic curve.

There is expediently provision that the solenoid valve is a valve which is open in the currentless state. Valves which are open in the currentless state have an opening force which is permanently predefined owing to their design and which is brought about, for example, by a mechanical spring. This opening force which is predefined owing to the design accumulates with a force which also acts in the opening direction and is brought about by the pressure present at the valve. The additional occurrence of a hysteresis effect which acts additionally in the opening direction, and, in particular, a failure to take account of said hysteresis effect, can make efficient and rapid pressure regulation within the brake system difficult. Therefore, the switchover method according to the invention provides particular advantages in particular in the case of valves which are open in the currentless state.

Furthermore, it is advantageous that the solenoid valve is an isolating valve of the electrohydraulic brake system. The isolating valve is customarily used to carry out what are referred to as overflow regulating processes, which reduces again a pressure build-up which has been generated but which exceeds a pressure request. In this context, the isolating valve is supplied with current in such a way that it opens as soon as a predefined setpoint pressure is exceeded, and therefore reduces the pressure which exceeds the setpoint pressure. Since the isolating valve is therefore customarily used for precise and rapid adjustment of pressures in the brake system, the application of the inventive switchover method in an isolating valve provides further advantages.

There is expediently provision that the current-pressure characteristic curve and/or the hysteresis characteristic diagram and/or the hysteresis characteristic curve are determined on a valve-specific basis. This improves the accuracy of the pressure regulation in that the respective hysteresis characteristic can be compensated more precisely. The valve-specific determination can take place here, for example, on a test bench before the installation of the solenoid valve in the brake system or after the installation in the brake system, by means of suitable known calibration methods.

There is preferably provision that the current-pressure characteristic curve and/or the hysteresis characteristic diagram and/or the hysteresis characteristic curve are stored in an electronic memory of an electronic control unit of the electrohydraulic brake system. Since the solenoid valves are controlled by means of the electronic control unit and the latter as a rule comprises an electronic memory, the current-pressure characteristic curve or the hysteresis characteristic diagram or the hysteresis characteristic curve can therefore be made available easily and at comparatively low additional cost.

An aspect of the present invention also relates to an electronic brake system which comprises at least one master cylinder for supplying hydraulic fluid, at least one inlet valve for inputting a hydraulic pressure into at least one brake cylinder, at least one outlet valve for outputting the hydraulic pressure from the at least one brake cylinder, at least one electrically drivable hydraulic pump for building up hydraulic pressure according to a pressure request of an electronic control unit and at least one analogized isolating valve. The electronic control unit carries out pressure regulation by means of the isolating valve and a current-pressure characteristic curve, stored in an electronic memory of the electronic control unit, of the isolating valve. The electronic brake system according to the invention is distinguished by the fact that in addition a hysteresis characteristic diagram and/or a hysteresis characteristic curve of the isolating valve are stored in the electronic memory. This provides the advantage that the information which is necessary to compensate hysteresis characteristics of the solenoid valves which occur is available for precise and rapid pressure regulation within the brake system, and can be used when necessary.

There is preferably provision that the brake system carries out the method according to the invention. This results in the advantages already described with respect to improved, more efficient and more precise pressure regulation.

Furthermore, an aspect of the invention relates to a use of the electrohydraulic brake system for hydraulic pressure regulation in an adaptive cruise control system and/or cruise control system of a motor vehicle.

### BRIEF DESCRIPTION OF THE DRAWINGS

Further preferred embodiments can be found in the dependent claims and in the following description of an exemplary embodiment with reference to figures, in which:

FIG. 1 is a schematic view of a current-dependent and pressure-dependent hysteresis characteristic curve of a solenoid valve,

FIG. 2 shows a pressure changing process which comprises a switchover of a solenoid valve according to the prior art and according to the method according to the invention, and

FIG. 3 shows a possible embodiment of an electrohydraulic brake system according to the invention.

### DETAILED DESCRIPTION OF THE PREFERRED EMBODIMENTS

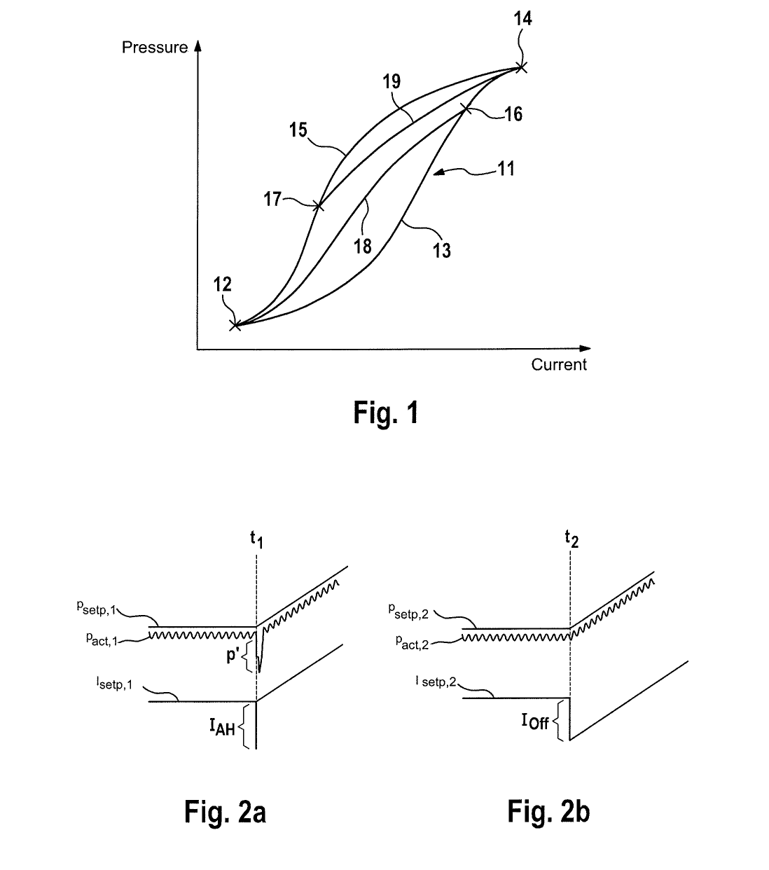

FIG. 1 illustrates by way of example a current-dependent and pressure-dependent hysteresis characteristic curve 11 of a solenoid valve. The x-axis denotes the current which is applied to the solenoid valve, and the y axis represents a pressure which is present at the solenoid valve and at which the solenoid valve opens with the respectively set application of current. When the application of current is increased—starting from point 12—the magnetic force follows at the solenoid valve, which force, according to the example, keeps the solenoid valve closed, that is to say holds the valve tappet in the closed position, line 13 at relatively high pressures. The maximum magnetic force is reached at point 14. This corresponds to the maximum pressure which the solenoid valve can withstand without opening. If the application of current is then reduced again—starting from point 14—the magnetic force follows, and therefore the pressure at which the solenoid valve opens, line 15. As can be seen, the hysteresis effect results in the phenomenon according to which to set the same value on the y axis it is necessary to select two different values on the x axis, depending on the starting point of the change in current, i.e. depending on the point of the switchover. If the current, coming from point 12, is increased along line 13 only as far as point 16 and a switchover already takes place here, that is to say a reduction in current, the opening pressure follows line 18. Therefore, for each value on the y axis there are already three different values on the x axis, which each have to be selected as a function of the point of the switchover. This ambiguity increases in the opposite case when the current is reduced to point 17 starting from point 14, and is increased again from point 17. In this case, the opening pressure follows line 19. It is therefore apparent that the selection of the point of the switchover leads to a respectively individual current-pressure behavior of the solenoid valve, which in turn makes pressure regulations significantly more difficult.

FIG. 2a shows a pressure changing process according to the prior art, and FIG. 2b shows a pressure changing process according to the inventive switchover method. The setpoint pressure p_{setp,1} on FIG. 2a experiences an increase in pressure at the time t₁, which increase in pressure is illustrated by the rise in the setpoint pressure curve. According to the prior art, in FIG. 2a a brief, so-called anti-hysteresis pulse I_{AH} is applied to the solenoid valve. Apart from this anti-hysteresis pulse I_{AH}, the current curve I_{setp,1} corresponds very largely to the profile of the setpoint pressure p_{setp,1}. The actual pressure p_{act,1} therefore also very largely follows the profile of p_{setp,1}, but deviates significantly therefrom at p′, since the anti-hysteresis pulse I_{AH} brings about hydraulic feedback. However, the anti-hysteresis pulse I_{AH} is necessary according to the prior art so that the actual pressure p_{act,1} can follow the setpoint p_{setp,1}.

FIG. 2b shows the setpoint pressure p_{setp,2}. At the time t₂, the setpoint pressure p_{setp,2} is increased. In order to approximate the actual pressure p_{act,2} to the setpoint pressure p_{setp,2}, the setpoint current I_{setp,2} is correspondingly changed, wherein a present hysteresis characteristic is compensated directly by applying a current offset I_{off} to I_{setp,2}. I_{off} corresponds according to the example to a change in pressure of 4 bar. As is apparent, the actual pressure p_{act,2} follows the setpoint pressure p_{act,2} without pressure dips such as are typically caused by an anti-hysteresis pulse I_{AH}.

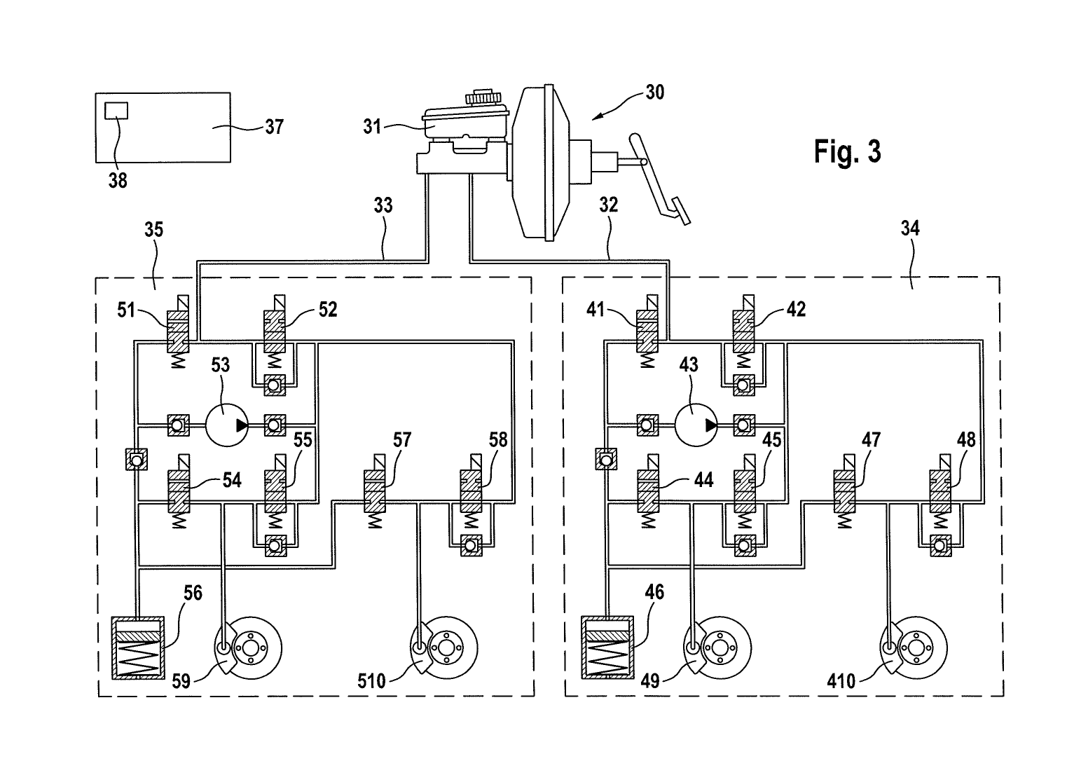

FIG. 3 shows a schematic design of an electrohydraulic brake system (30) of a motor vehicle. The master cylinder 31 is hydraulically coupled to brake circuits 34, 35 via hydraulic lines 32, 33. Each brake circuit 34, 35 comprises in each case a changeover valve 41, 51, an isolating valve 42, 52 as well as in each case two wheel brake cylinders 49, 410, 59, 510. Each wheel brake cylinder 49, 410, 59, 510 is assigned in each case an inlet valve 45, 48, 55, 58 as well as in each case an outlet valve 44, 47, 54, 57. Furthermore, each brake circuit 34, 35 comprises in each case a low pressure accumulator 46, 56 and in each case an electrically drivable hydraulic pump 43, 53. Hydraulic pumps 43, 53 generate here in each case a hydraulic pressure which as a rule slightly exceeds a pressure request which is output by the electronic control unit 37. In order to reduce again this pressure which exceeds the pressure request, the isolating valves 52, 42 each carry out an overflow regulation process. In this context, the isolating valves 52, 42 are energized in such a way that they open as soon as the actual pressure exceeds the pressure request. When there is a change in the pressure request, the isolating valves 52, 42 experience a change in their energization which corresponds to the change in the pressure request. Since the pressure requests in brake circuits 34, 35 are different, isolating valves 52, 42 are also actuated or energized differently. Since the isolating valves 52, 42 are solenoid valves which are subject to a magnetic hysteresis effect, the hysteresis characteristic which is currently present at them has to be compensated immediately and without a preceding change in the hysteresis characteristic in order to permit rapid, precise and efficient actuation. For this purpose, not only the current-pressure characteristic curves of the isolating valves 52, 42 but also the current-dependent and pressure-dependent hysteresis characteristic diagrams of the isolating valves 52, 42 are stored in the electronic memory 38 of the electronic control unit 37. The current-dependent and pressure-dependent values of the respective current offset are then read out from the hysteresis characteristic diagrams and added to the different current-pressure characteristic curves of the isolating valves 52, 42. The magnetic hysteresis characteristics which are present at the isolating valves 52, 42 are therefore compensated and a rapid, precise and efficient pressure regulating process becomes possible.

1. A switchover method for a solenoid valve operated in analogized form in an electrohydraulic brake system,
in which a closed position, an open position and a multiplicity of intermediate positions can be assumed by the solenoid valve in accordance with electrical actuation or regulation, and
wherein the actuation or regulation is performed in accordance with a known current-pressure characteristic curve of the solenoid valve, wherein when there is a switchover of the solenoid valve a pressure-dependent and/or current-dependent magnetic hysteresis characteristic of the solenoid valve is compensated directly without a preceding change in the present hysteresis characteristic.

2. The method as claimed in claim 1, wherein the switchover is performed from a valve-opening movement to a valve-closing movement.

3. The method as claimed in claim 1, wherein
magnetic hysteresis characteristic is compensated by a current offset which is added to the current-pressure characteristic curve.

4. The method as claimed in claim 3, wherein in that the current offset is determined as a function of the setpoint pressure and/or setpoint current present at the solenoid valve directly before the switchover is performed.

5. The method as claimed in claim 4, wherein in that a value of the current offset is read out from a current-dependent and/or pressure-dependent hysteresis characteristic diagram or a current-dependent and/or pressure-dependent hysteresis characteristic curve.

6. The method as claimed in claim 1, wherein
the solenoid valve is a valve which is open in the currentless state.

7. The method as claimed in claim 1, wherein
in that the solenoid valve is an isolating valve of the electrohydraulic brake system.

8. The method as claimed in claim 5, wherein
the current-pressure characteristic curve and/or the hysteresis characteristic diagram and/or the hysteresis characteristic curve are determined on a valve-specific basis.

9. The method as claimed in claim 5, wherein
the current-pressure characteristic curve and/or the hysteresis characteristic diagram and/or the hysteresis characteristic curve are stored in an electronic memory of an electronic control unit of the electrohydraulic brake system.

10. An electrohydraulic brake system, comprising:
at least one master cylinder for supplying hydraulic fluid,
at least one inlet valve for inputting a hydraulic pressure into at least one brake cylinder,
at least one outlet valve for outputting the hydraulic pressure from the at least one brake cylinder,
at least one electrically drivable hydraulic pump for building up hydraulic pressure according to a pressure request of an electronic control unit and
at least one analogized isolating valve,
wherein the electronic control unit carries out pressure regulation by means of the isolating valve and a current-pressure characteristic curve, stored in an electronic memory of the electronic control unit, of the isolating valve, wherein in addition a hysteresis characteristic diagram and/or a hysteresis characteristic curve of the isolating valve are stored in the electronic memory.

11. The brake system as claimed in claim 10, wherein the brake system carries out a method as claimed in claim 1.

12. The use of the electrohydraulic brake system as claimed in claim 10 for hydraulic pressure regulation in an adaptive cruise control system and/or cruise control system of a motor vehicle.

13. The use of the electrohydraulic brake system as claimed in claim 11 for hydraulic pressure regulation in an adaptive cruise control system and/or cruise control system of a motor vehicle.
